(19) United States
(12) Patent Application Publication
(10) Pub. No.: US 2007/0193528 A1
(43) Pub. Date: Aug. 23, 2007

(54) Disposable pet carrier

(76) Inventor: Gary Scaife, Las Vegas, NV (US)

Correspondence Address: CHRISTIE, PARKER & HALE, LLP, PO BOX 7068, PASADENA, CA, 91109-7068, US

(21) Appl. No.: 11/357,790

(22) Filed: Feb. 17, 2006

(51) Int. Cl. A01K 1/03

(52) U.S. Cl. 119/497

(57) ABSTRACT

Carriers for carrying pets are generally discussed herein with particular discussions extended to disposable pet carriers made from multi-layer sheets having absorbent and shielding properties. The carriers may be carried like a tote pack or worn around the shoulder like a pouch pack. The absorbent property is configured to soak up waste or discharge emitted by a sick or nervous pet, or for other reasons, while the shielding property prevents the waste or discharge from migrating to the surface of the carrier and wetting the user.

Carriers for carrying pets are generally discussed herein with particular discussions extended to disposable pet carriers made from multi-layer sheets having absorbent and impermeable properties.

### BACKGROUND

Prior art pet carriers are well known in the art for shipping, carrying, and transporting pets. Exemplary prior art carriers include U.S. Pat. No. 4,736,707 directed to a transport box made from corrugated cardboard having a floor portion 12 for forming a dam means 22; U.S. Pat. No. 5,383,422 directed to a disposable cardboard doghouse of collapsible construction; and U.S. Pat. No. 5,046,457 directed to an animal enclosure apparatus adapted to be assembled entirely by a user from a single symmetrically-arranged foldable blank of biodegradable, disposable material. Another prior art patent is U.S. Pat. No. 5,193,486 to Kitchens directed to a convertible pet carrier. The carrier disclosed in the '486 patent may be used to carry pets and is convertible into a pet jacket for wearing by a pet. The contents of these prior art patents are expressly incorporated herein by reference as if set forth in full.

Although the carriers disclosed in these prior art patents are economical and effective for their intended purposes, they are far from perfect. Among other things, other than the carrier disclosed in the '486 Kitchens patent, these carriers are configured as enclosures that confine and reduce the pets to articles of manufacture to be separated from their loving owners during shipping or transporting. Because these pets are isolated when using these carriers, they can become traumatized and stressed during the ordeal.

Although the carrier disclosed in the '486 patent is configured to hold a pet in close proximity to its owner thus allowing interactions between the owner and his pet, it does not incorporate means for retaining wastes and the like, which are often a problem when the pet is nervous and/or is sick. Accordingly, there is a need for a carrier that is configured to carry a pet in close proximity to its owner and that has waste retention means for containing mishaps.

### SUMMARY

The present invention may be implemented by providing a carrier for transporting a pet, the carrier comprises a main body section defining a holding space, a base attached to the main body section forming a bottom end, which is opposite an open end; and one or more straps configured to be worn around a shoulder or a waste coupled to the main body section; wherein the base and the main body section are made from a multi-layer sheet comprising a layer having absorbent property and a layer having at least one of low and zero water permeable property.

The present invention may also be practiced by providing a carrier for transporting a pet, the carrier comprises two straps attached to a main body section, which is sewn to a base section; the main body section defining an interior cavity for accommodating a pet; and wherein at least one of the main body section and the base incorporates a multi-layer sheet comprising a polyester blend layer, an absorbent layer, and a low or zero fluid permeable barrier layer.

In yet other aspects of the present invention, there is provided a method for transporting a pet comprising the steps: a) obtaining a carrier, the carrier comprising: 1) two straps attached to a main body section, which is attached to a base section; the main body section defining an interior cavity for accommodating a pet; and wherein at least one of the main body section and the base incorporates a multi-layer sheet comprising a polyester blend layer, an absorbent layer, and at least one of low and zero fluid permeable barrier layer; and b) placing a pet inside the interior cavity of the main body section.

Aspects of the present invention further include provisions for attaching the straps to the main body section either through sewing or incorporating anchors.

Aspects of the present invention further includes provisions for adding decorative indicia or information on the main body section through printing, screening, or embroidering.

Still other aspects of the present invention include provisions for adjusting the straps through quick release and adjustable buckles.

These and other features and advantages of the present invention will become appreciated as the same become better understood with reference to the specification, claims and appended drawings.

### BRIEF DESCRIPTION OF THE DRAWINGS

The drawings appended herein include:

FIG. 1 is a semi-schematic front view of a carrier provided in accordance with aspects of the present invention, shown with a pet disposed therein;

FIG. 2 is a semi-schematic cut-away perspective view of a carrier provided in accordance with aspects of the present invention; which shows the main body section incorporating multi-layer sheet;

FIG. 3 is a semi-schematic depiction of a multi-layer sheet provided in accordance with aspects of the present invention; which includes a five-layer sheet;

FIG. 4 is a semi-schematic exploded perspective view of a carrier provided in accordance with aspects of the present invention;

FIG. 5 is a side view of the carrier of FIG. 4;

FIG. 6 is a semi-schematic side view of an alternative carrier provided in accordance with aspects of the present invention; and

FIGS. 7 and 8 are semi-schematic depictions of material patterns for constructing the carrier of FIG. 6.

### DETAILED DESCRIPTION

The detailed description set forth below in connection with the appended drawings is intended as a description of the presently preferred embodiments of disposable pet carriers (herein “carriers”) provided in accordance with aspects of the present invention and is not intended to represent the only forms in which the present invention may be constructed or utilized. The description sets forth the features and the steps for constructing and using the carriers of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like or similar elements or features.

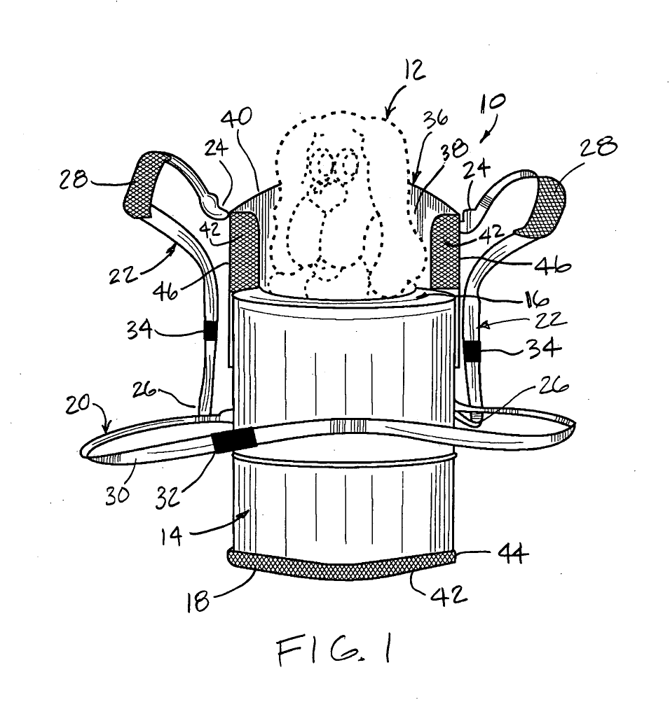

Referring now to FIG. 1, a semi-schematic side view of a carrier 10 having a pet 12 disposed therein is provided in accordance with aspects of the present invention. As used herein, the term pet includes any number of small animals, including ferrets, rabbits, dogs, and cats. In one exemplary embodiment, the carrier 10 comprises a main body section 14 defining a holding space for accommodating the pet 12. While the main body section 14 may incorporate any number of shapes and sizes, in one exemplary embodiment, the main body section has a generally cylindrical shape comprising an open first end 16 and a closed second end 18. As is readily apparent to a person of ordinary skill in the art, the pet 12 is configured to be placed into the holding space via the open first end 16.

In one exemplary embodiment, the carrier incorporates one or more straps 20 for either holding the carrier 10, like a tote pack, or for wearing the carrier, like a front pouch pack, a front back pack, or a backpack. Preferably, the carrier 10 incorporates two shoulder straps 22 each having a first end 24 connected generally above the first open end 16, or have sections that flow therefrom extending above the first open end, and a second end 26 connected to the main body section 14. In a preferred embodiment, the two shoulder straps 22 incorporate cushioning pads 28 for cushioning impacts between the shoulder straps 22 and a user's shoulder when the carrier is worn as a front pouch pack or backpack. The cushioning pads 28 may be made from any prior art pads including foam pads and pads made by folding one or more sheets into a desired pad shape having sufficient thickness for cushioning.

In one exemplary embodiment, a waist strap 28 is incorporated for distributing the weight of the carrier and its content over a wider area, i.e., over the shoulder and waist. In a preferred embodiment, the waist strap 28 incorporates a quick release buckle 32 (frequently used with prior art back pack waist straps) and the shoulder straps 22 each incorporate an adjustable buckle 34 for adjusting the length or slack of the shoulder straps.

In one exemplary embodiment, a back panel 36 is incorporated, to which the main body section 14 attaches. The back panel 36 comprises a panel section 38 and a top edge 40 extending above the first open end 16. The back panel 36 provides added protection by providing a layer between the pet 12 and the user or pet owner. As further discussed below, slots or compartments may be sewn into the back panel 36 for accommodating one or more plastic strips to provide added rigidity. Alternatively, the back panel 36 may be eliminated and the shoulder straps 22 attached directly to the main body section 14.

In one exemplary embodiment, a tear resistant over-layer 42 is incorporated around the lower periphery 44 of the closed second end 18 to resist tearing between the main body section 14 and a bottom carrier layer (not shown) from the weight of the pet 12. In another embodiment, a tear resistant over-layer 42 is incorporated on each of the side edges 46 of the back panel 36 to resist tearing between the main body section 14 and the back panel. The carrier may further include a string adjustment loop at the open first end 16, which resembles an adjustment loop used with swimming trunks, an elastic stretch section, or a combination thereof. The string adjustment loop may be adjusted to decrease the diameter of the first open end to therefore prevent the pet from jumping or falling out from the carrier.

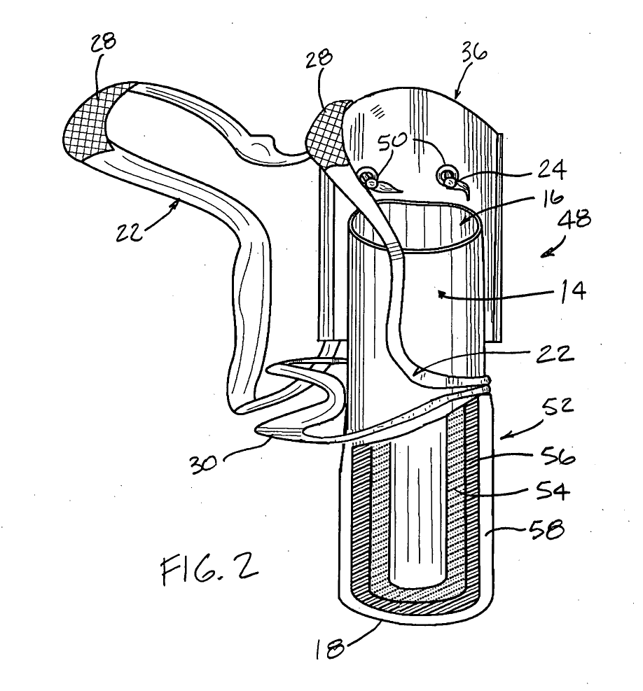

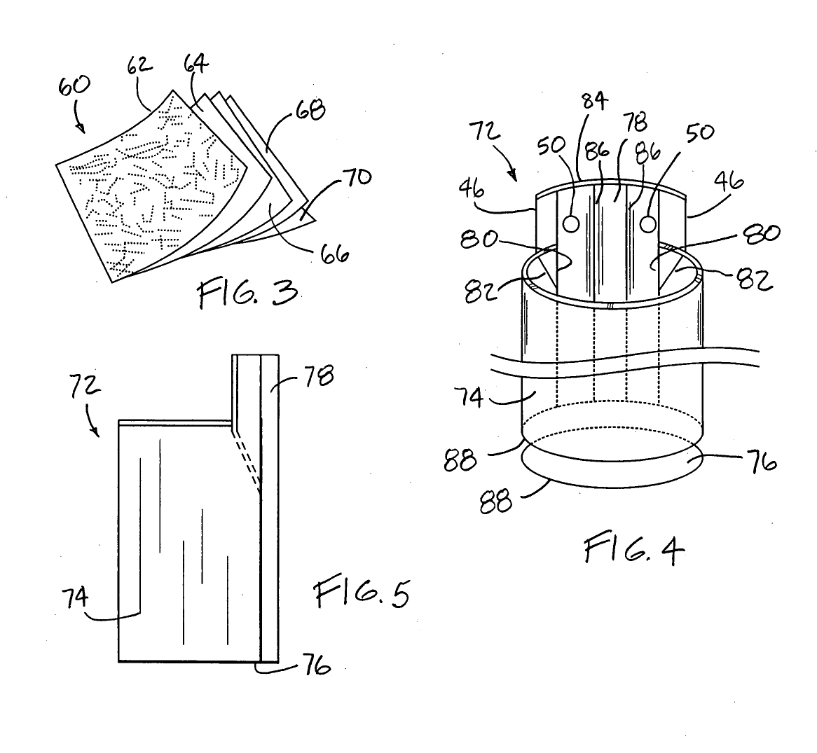

FIG. 2 is a semi-schematic partial cut-away perspective view of a carrier provided 48 provided in accordance with aspects of the present invention. In one exemplary embodiment, the carrier incorporates a pair of anchors 50, which are doughnut-shape metallic rings embedded or crimped into the back panel 36. The ends 24 of the two shoulder straps 22 may be placed through the anchors 50 and tied into knots to prevent the ends from slipping back out. This allows the shoulder straps 22 to be attached to the back panel 36 without sewing. The other ends of the shoulder straps 22 and the two ends of the waist strap 30 may similarly be attached to the carrier using additional anchors.

In one exemplary embodiment, the main body section 14 comprises a multi-layer sheet 52 of absorbent and low or zero water permeable layers. The multi-layer sheet is configured to absorb liquid waste or discharge emitted by a pet yet is nearly impenetrable through to the exterior surface of the main body section. In one particular aspect of the present invention, the multi-layer sheet 52 comprises an inner absorbent layer 54 of a high absorption to weight ratio, such as a polyester fiber and cotton blend, a terry cloth, or 100% cellulose heavy duty J Cloth by Bemcot Wiper. The middle layer 56 is preferably a polyurethane layer for leakage-prevention. However, other low or zero water permeable layer may be used aside from a polyurethane layer, including Mylar, acetate, Polyethylene Sheeting (HDPE), and vinyl. A layer having low or zero fluid permeable property is a layer that prevents or inhibits fluid transmission, such as water or urine, from one side of the layer to the other side of the layer so as to soak or wet an object or thing that touches the originally dried side. Ideally, the layer should prevent or inhibit transmission for periods of at least two to ten hours, with a minimum of four hours being more preferred.

Finally, the outer layer 58 may be a fabric, such as brushed polyester knit, brushed nylon knit, brushed cotton knit, a nylon or cotton knit, or a blend of any of the foregoing. The third outer layer 58 may also be a non-woven polyester fiber or Tyvek®. The three layers may be laminated together using urethane adhesive or other known prior art adhesives, used, for example, in feminine and diaper products. Fabric adhesive may also be used. In an alternative embodiment, an inner-most layer, positioned before the first inner absorbent layer 54, of a polyfilm is included. The polyfilm, as used in disposable diapers, allows air to breath and fluid or liquid to flow only one way thus keeping the animal dry.

As is readily apparent to a person of ordinary skill in the art, the carrier is ideally suited for carrying or transporting sick pets, nervous pets, and for a day trip or short trip. For example, when coming from a vet clinic, the pet may have a bad reaction to the treatments and therefore have symptoms such as diarrhea, vomiting, and uncontrollable or excessive urination. The carrier allows the pet to remain dry while absorbing the waste or discharge produced by the pet. The carrier may also be used to absorb blood, urine, or vomit when transporting the pet to a vet clinic. For example, the pet may have food poisoning, was involved in a fight and is nervous, is bleeding, has stepped on something sharp and is bleeding, etc. In short, the carrier serves as a means for transporting a pet while maintaining a high degree of sanitary.

FIG. 3 is a semi-schematic depiction of a multi-layer sheet 60 usable with a carrier provided in accordance with aspects of the present invention. In one exemplary embodiment, the multi-layer sheet 60 is formulated to be both absorbent, durable, generally impermeable to an exterior surface, and disposable. In one implementation, the multi-layer sheet 60 incorporates a polyester blend membrane inner layer 62 that allows flow to transfer one way and generally inhibits reverse flow. An example of a polyester blend membrane is a Pearl Izumi Contour fabric. An additional example is a membrane layer used in diapers, known as a polyfilm layer made from polyresin. A second most inner layer 64 is an absorbent layer of paper/cotton blend. Exemplary paper/cotton blends are those offered by Lillian Vernon 50/50 cotton/paper blend and 1066 Cellulose Cotton/Paper Blend offered by Marko, Inc. A third middle layer 66 is preferably a polyester/cotton blend layer chosen for additional absorbency. In one exemplary embodiment, a thin vinyl backing is bonded to the polyester/cotton blend to deter or inhibit deterioration when the blend layer is in contact with and absorbs fluid.

A fourth layer 68 is preferably a low to zero liquid permeable layer for preventing liquid flow or transmission from the inner most layer 62 to the outer most layer 70. In one exemplary embodiment, the fourth layer 68 is a polyurethane layer, a vinyl layer, an acetate layer, or other equivalent plastic sheets. Finally, the outer most layer 70 is preferably a finishing layer, which may be a decorative layer, an aesthetically appealing layer, a tear resistant layer, a soft layer (such as a terry cloth layer) or a combination thereof such as a blend. As is readily apparent to a person of ordinary skill in the art, the multi-layer sheet 60 is designed so that the inner most layer 62 faces the inside and contacts a pet while the outer most layer 70 faces the outside and is configured to contact a user or pet owner. In one exemplary embodiment, the multi-layer sheet 60 is laminated using a non-drying adhesive such as Duro's All Purpose Spray Adhesive composed of n-hexane, dimethyl ether and acetone. However other non-drying adhesives can be used as long as the adhesive, once applied, would not be readily combustible and offers minimal air and fluid flow resistance.

FIG. 4 is a semi-schematic exploded perspective view of a carrier 72 provided in accordance with aspects of the present invention. The carrier 72 may be made by obtaining and cutting the multi-layer sheet 60 of FIG. 3 into a first pattern 74, a second pattern 76, and a third pattern 78. The first pattern 74 forms a main body section of the carrier, the second pattern 76 forms a base or floor of the carrier, and the third pattern 78 forms a back panel of the carrier. Preferably, the patterns are individually made to size and shape and the multi-layer sheets bonded along a common edge instead of cutting from a large raw sheet stock. The first pattern 74 is initially sewn to the third pattern along two seams 80. For added strength, the two back panel edges 46 are also sewn to the first pattern 74 along two additional thread lines 82. Alternatively, the patterns are attached to one another using known prior art adhesive.

In one exemplary embodiment, two anchors 50 are mounted to the third pattern 78 for supporting two shoulder straps. The anchor locations on the third pattern 78 may vary without deviating from the spirit and scope of the present invention. In one exemplary embodiment, a longitudinal cavity 84 may be incorporated for receiving a rigid plastic strip or pressed fiber (not shown) to provide added rigidity for the third pattern. The plastic strip or pressed fiber may include ribs and curvatures for added strength. The longitudinal cavity 84 may be formed by sewing two generally parallel central thread lines 86 on the third pattern 78. As previously discussed, tear resistant over-layers, such as Tyvek®, may be incorporated along high stress corners to provide added strength and resistant against tear. The second pattern 76 may be attached to the first pattern 74 and the third pattern 78 by sewing the second pattern along the common edge 88.

FIG. 5 is a semi-schematic side view of the carrier 72 of FIG. 4. The carrier 72 is not shown with any shoulder or waist strap. However, it is understood that both shoulder and waist straps may be incorporated by tying the ends of the straps to anchors points incorporated on the carrier or alternatively sew the ends of the straps directly to the carrier. As previously discussed, the straps are preferably adjustable by incorporating quick release buckles and adjustment buckles that can be found in prior art backpacks.

FIG. 6 is a semi-schematic side view of an alternative carrier 90 provided in accordance with aspects of the present invention. In one exemplary embodiment, the carrier 90 comprises a main body section 92 defining a holding space and a base or bottom 94. The base 94 is attached to the main body section 92 along a common edge 96. In one application of the present invention, the carrier 90 resembles a tote pack and incorporates a pair of straps 98 mounted on two sides of an imaginary line drawn through a horizontal center of the main body section 92. The straps 98 are preferably made from the same material as the main body section 92 and are attachable thereto using round or square anchors 100. Alternatively, the straps 98 may be sewn to the main body section 92.

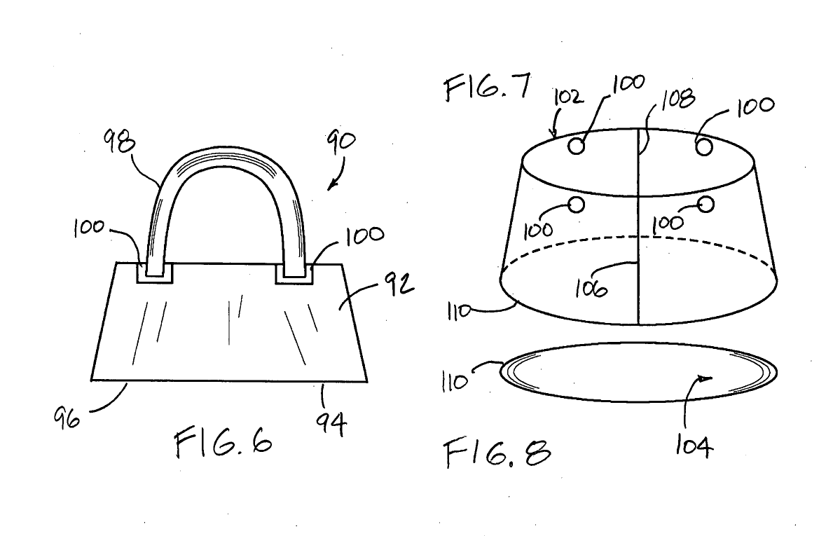

FIG. 7 is a semi-schematic perspective view of a first pattern 102 and FIG. 8 is a semi-schematic perspective view of a second pattern 104 provided in accordance with aspects of the present invention. The patterns may be cut from a multi-layer sheet 60 shown in FIG. 3. In one exemplary embodiment, the first pattern 102 may be formed by cutting a strip and sewing the two ends of the strip along a seam, or along two seams 106, 108 if the first pattern comprises two shorter strips having four free ends. Four anchors 100 are incorporated in the first pattern 102 for cooperating with hand or shoulder straps.

The second pattern 104 may be sewn to the first pattern along their common edge 110. Once the first and the second patterns 102, 104 are attached to one another and two straps 98 are attached to the four anchors 100, the carrier resembles the carrier shown in FIG. 6.

Although not shown, tear-resistant over-layers may be incorporated at high stress points to resist tearing. Printing, silk screening, and other decorative indicia, such as embroidery, may also be incorporated on the carrier.

Although limited embodiments of the carriers and their components have been specifically described and illustrated herein, many modifications and variations will be apparent to those skilled in the art. For example, the carriers may incorporate different sheets within the multi-component layer to perform the absorbent, tear-resistant, and barrier functions. Also, a terry cloth fabric, a single layer fabric, or a fabric blend may be used as a main body section and attached to a multi-layer base to form yet another alternative carrier. Still further more, although a three layer sheet and a five layer sheet and the specific material make-up of the layers are disclosed, they are exemplary only and that variations are permissible provided the multi-layer sheets include at least one absorbent layer and one lower or zero water permeable layer. Furthermore, while the carriers shown and described are in a tote pack configuration and a front pouch pack configuration, other shapes and configurations may be incorporated without deviating from the spirit and scope of the present invention. The carriers are inexpensive to produce and therefore disposable whenever deemed not sanitary. Accordingly, it is to be understood that carriers and their components constructed according to the principles of this invention may be embodied other than as specifically described herein. The invention is also defined in the following claims.

What is claimed is:

1. A carrier for transporting a pet, the carrier comprises a main body section defining a holding space, a base attached to the main body section forming a bottom end, which is opposite an open end; and one or more straps configured to be worn around a shoulder or a waste coupled to the main body section; wherein the base and the main body section are made from a multi-layer sheet comprising a layer having absorbent property and a layer having at least one of low and zero water permeable property.

2. The carrier of claim 1, where the base is sewn to the main body section to from an enclosed end.

3. The carrier of claim 1, further comprising a back panel attached to the main body section.

4. The carrier of claim 3, wherein the back panel further comprises a rigid member mounted thereto for providing rigidity to the carrier.

5. The carrier of claim 1, further comprising a polyfilm inner layer positioned closer to the holding space than to the at least one of lower and zero water permeable property.

6. The carrier of claim 1, where the one or more straps comprise a shoulder strap and a waste strap.

7. The carrier of claim 1, wherein the one or more straps are adjustable.

8. The carrier of claim 1, further comprising design or information indicia on an outer layer.

9. The carrier of claim 1, further comprising a tear-resistant layer.

10. A carrier for transporting a pet, the carrier comprises two straps attached to a main body section, which is sewn to a base section; the main body section defining an interior cavity for accommodating a pet; and wherein at least one of the main body section and the base incorporates a multi-layer sheet comprising a polyester blend layer, an absorbent layer, and a low or zero fluid permeable barrier layer.

11. The carrier of claim 10, further comprising a polyfilm inner layer.

12. The carrier of claim 10, wherein the absorbent layer is a cotton blend layer.

13. The carrier of claim 10, wherein the two straps are adjustable.

14. The carrier of claim 10, wherein the lower or zero fluid permeable barrier layer comprises a plastic layer.

15. A method for transporting a pet comprising the steps:
a) obtaining a carrier, the carrier comprising:
1) two straps attached to a main body section, which is attached to a base section; the main body section defining an interior cavity for accommodating a pet; and wherein at least one of the main body section and the base incorporates a multi-layer sheet comprising a polyester blend layer, an absorbent layer, and at least one of low and zero fluid permeable barrier layer; and
b) placing a pet inside the interior cavity of the main body section.

16. The method of claim 15, further comprising the step of wearing the straps.

17. The method of claim 15, further comprising the step of removing the pet from the interior cavity.

18. The method of claim 15, further comprising an inner barrier layer that permits fluid to flow only one way.

19. The method of claim 18, wherein the inner barrier layer is a polyfilm.

20. The method of claim 15, further comprising a back panel attached to the main body section.
